(19) United States
(12) Patent Application Publication
(10) Pub. No.: US 2026/0042675 A1
(43) Pub. Date: Feb. 12, 2026

(54) MOLECULAR SIEVE SSZ-91 WITH HIERARCHICAL POROSITY, METHODS FOR PREPARING, AND USES THEREOF

(71) Applicant: CHEVRON U.S.A. INC., San Ramon, CA (US)

(72) Inventors: Adeola Florence OJO, Pleasant Hill, CA (US); Joel Edward SCHMIDT, Oakland, CA (US); Yihua ZHANG, Albany, CA (US); Guan-Dao LEI, Walnut Creek, CA (US)

(21) Appl. No.: 19/100,494

(22) PCT Filed: Aug. 1, 2023
(86) PCT No.: PCT/US2023/071409

§ 371 Date: Jan. 31, 2025

Related U.S. Application Data
(60) Provisional application No. 63/394,286, filed on Aug. 1, 2022.

(51) Int. Cl. C01B 39/06; B01J 29/74; C10G 45/64

(52) U.S. Cl. CPC C01B 39/06; B01J 29/7461; C10G 45/64; C01P 2002/72; C01P 2006/12; C01P 2006/14; C01P 2006/17; C10G 2300/70

(57) ABSTRACT

Disclosed are crystalline mesoporous molecular sieves based on molecular sieve SSZ-91, methods for making mesoporous SSZ-91, and use of mesoporous SSZ-91 in hydroconversion applications. Mesoporous molecular sieve SSZ-91 is characterized as: having a low degree of faulting, having a low aspect ratio that inhibits hydrocracking as compared to conventional ZSM-48 materials having an aspect ratio of greater than 8, being substantially phase pure, and having a total pore volume (measured at P/P₀ of 0.95) in the mesopore diameter range is at least about 0.2 cc/g and wherein the micropore volume is at least 0.05 cc/g.

### CROSS-REFERENCE TO RELATED APPLICATIONS

This application is related to and claims priority benefit to U.S. Provisional Appl. Ser. No. 63/394,286, filed on Aug. 1, 2022, herein incorporated in its entirety.

### TECHNICAL FIELD

Described herein are crystalline molecular sieves, belonging to the ZSM-48 family of molecular sieves, designated as SSZ-91, having hierarchical porosity, methods for preparing such SSZ-91 molecular sieves and uses thereof.

### BACKGROUND

Because of their unique sieving characteristics, as well as their catalytic properties, crystalline molecular sieves and molecular sieves are especially useful in applications such as hydrocarbon conversion, gas drying and separation. Although many different crystalline molecular sieves have been disclosed, there is a continuing need for new molecular sieves with desirable properties for gas separation and drying, hydrocarbon and chemical conversions, and other applications. New molecular sieves may contain novel internal pore architectures, providing enhanced selectivities in these processes.

Molecular sieves have distinct crystal structures which are demonstrated by distinct X-ray diffraction patterns. The crystal structure defines cavities and pores which are characteristic of the different species.

Molecular sieves are classified by the Structure Commission of the International Zeolite Association according to the rules of the IUPAC Commission on Zeolite Nomenclature. According to this classification, framework type zeolites and other crystalline microporous molecular sieves, for which a structure has been established, are assigned a three letter code and are described in the “Atlas of Zeolite Framework Types” Sixth Revised Edition, Elsevier (2007) and the Database of Molecular sieve Structures on the International Zeolite Association's website (http://www.iza-online.org).

The structure of a molecular sieve can be either ordered or disordered. Molecular sieves having an ordered structure have periodic building units (PerBUs) that are periodically ordered in all three dimensions. Structurally disordered structures show periodic ordering in dimensions less than three (i.e., in two, one or zero dimensions). Disorder occurs when the PerBUs connect in different ways, or when two or more PerBUs intergrow within the same crystal. Crystal structures built from PerBUs are called end-member structures if periodic ordering is achieved in all three dimensions.

In disordered materials, planar stacking faults occur where the material contains ordering in two dimensions. Planar faults disrupt the channels formed by the material's pore system. Planar faults located near the surface limit diffusion pathways otherwise required in order to allow feedstock components to access the catalytically active portions of the pore system. Therefore, as the degree of faulting increases, the catalytic activity of the material typically decreases.

In the case of crystals with planar faults, interpretation of X-ray diffraction patterns requires an ability to simulate the effects of stacking disorder. DIFFaX is a computer program based on a mathematical model for calculating intensities from crystals containing planar faults. (See, M. M. J. Treacy et al., Proceedings of the Royal Chemical Society, London, A (1991), Vol. 433, pp. 499-520). DIFFaX is the simulation program selected by and available from the International Zeolite Association to simulate the XRD powder patterns for intergrown phases of molecular sieves. (See, “Collection of Simulated XRD Powder Patterns for Zeolites” by M. M. J. Treacy and J. B. Higgins, 2001, Fourth Edition, published on behalf of the Structure Commission of the International Zeolite Association). It has also been used to theoretically study intergrown phases of AEI, CHA and KFI molecular sieves, as reported by K. P. Lillerud et al. in “Studies in Surface Science and Catalysis”, 1994, Vol. 84, pp. 543-550. DIFFaX is a well-known and established method to characterize disordered crystalline materials with planar faults such as intergrown molecular sieves.

The designation ZSM-48 refers to a family of disordered materials, each characterized as having a one-dimensional 10-ring tubular pore system. The pores are formed of rolled up honeycomb-like sheets of fused tetrahedral 6-ring structures, and the pore aperture contains 10 tetrahedral-atoms. Zeolites EU-2, ZSM-30 and EU-11 fall into the ZSM-48 family of zeolites. The ZSM-48 family of molecular sieves consists of nine polytypes. These materials have very similar, but not identical, X-ray diffraction patterns. The polytypes may be at least partly distinguished according to their morphological differences. for example, polytype 6 consists of needle-like crystals having a diameter of ^{˜}20 nm and a length of ^{˜}0.5 μm. Another polytype, described as being a faulted polytype 6, consists of long, narrow crystals having a width of ^{˜}0.5 μm and a length of 4-8 μm.

Kirschhock and co-workers describe the successful synthesis of phase-pure polytype 6. (See, Chem. Mater. 2009, 21, 371-380). In their paper, Kirschhock and co-workers describe their phase-pure polytype 6 material (which they refer to as COK-8) as having a morphology consisting of long needle-like crystals (width, 15-80 nm; length, 0.5-4 μm) with a very large length/width ratio, growing along the interconnecting pore direction.

As indicated in the Kirschhock paper, molecular sieves from the ZSM-48 family of molecular sieves consist of 10-ring, 1-dimensional pore structures, wherein the channels formed by the interconnected pores extend perpendicular to the long axis of the needles. Therefore, the channel openings are located at the short ends of the needles. As the length-to-diameter ratio (also known as aspect ratio) of these needles increases, so does the diffusion pathway for the hydrocarbon feed. As the diffusion pathway increases, so does the residence time of the feed in the channels. A longer residence time results in increased undesirable hydrocracking of the feed with a concomitant reduction in selectivity.

There is a current and continuing need for molecular sieves in the ZSM-48 family that provide a lower degree of hydrocracking and provide other improvements over known ZSM-48 molecular sieves. A continuing need also exists for molecular sieves which are phase pure or substantially phase-pure, and have a low degree of disorder within the structure (a low degree of faulting).

### SUMMARY OF THE INVENTION

A family of crystalline molecular sieves with unique properties, referred to herein as “molecular sieve SSZ-91” or simply “SSZ-91,” is disclosed. Molecular sieve SSZ-91 is structurally similar to sieves falling within the ZSM-48 family of zeolites, and is characterized as: (1) having a low degree of faulting, (2) a low aspect ratio that inhibits hydrocracking as compared to conventional ZSM-48 materials having an aspect ratio of greater than 8, and (3) is substantially phase pure. SSZ-91 that has been further modified to enhance the pore size and pore size distribution characteristics is also described herein.

In contrast to conventional ZSM-48 material, a ZSM-48 material lacking any one of the three uniquely combined characteristics of SSZ-91 (low aspect ratio, low EU-1 content, high polytype 6 composition) will exhibit poor catalytic performance. SSZ-91, as well as SSZ-91 modified as further described herein, exhibits improved catalytic performance, particularly in hydroprocessing applications.

In one aspect, a molecular sieve is described herein as SSZ-91 having a mole ratio of 40 to 220 of silicon oxide to aluminum oxide. In its as-made form, the X-ray diffraction lines of Table 2 herein are indicative of SSZ-91. SSZ-91 materials are composed of at least 70% polytype 6 of the total ZSM-48-type material present in the product, as determined by DIFFaX simulation and as described by Lobo and Koningsveld in J. Am. Chem. Soc. 2012, 124, 13222-13230, where the disorder was tuned by three distinct fault probabilities. It should be noted the phrase “at least 70%” includes the case where there are no other ZSM-48 polytypes present in the structure, i.e., the material is 100% phase-pure polytype 6.

In another aspect, SSZ-91 is substantially phase pure. SSZ-91 contains an additional EUO-type molecular sieve phase in an amount of between 0 and 3.5 percent by weight (inclusive) of the total product.

Molecular sieve SSZ-91 has a morphology characterized as polycrystalline aggregates, each of the aggregates being characterized as being composed of crystallites collectively having an average aspect ratio of between 1 and 8 (inclusive). SSZ-91 exhibits a lower degree of hydrocracking than those ZSM-48 materials having a higher aspect ratio. An aspect ratio of 1 is the ideal lowest value, where the length and width are the same.

In a further aspect, SSZ-91 may include modified pore size and distribution characteristics, including, e.g., wherein the total pore volume (measured at P/P₀ of 0.95) in the mesopore diameter range (2-50 nm) is at least about 0.2 cc/g and the micropore volume is at least 0.05 cc/g.

In another aspect, there is provided a method of preparing a mesoporous crystalline SSZ-91 material by contacting under crystallization conditions (1) at least one source of silicon oxide; (2) at least one source of aluminum oxide; (3) at least one source of an element selected from Groups 1 and 2 of the Periodic Table; (4) hydroxide ions; and (5) hexamethonium cations under conditions leading to the formation of SSZ-91, followed by subjecting SSZ-91 to calcination conditions, and contacting the calcined SSZ-91 molecular sieve with an organic base, a quaternary ammonium salt, a quaternary ammonium base, an inorganic base, ammonium fluoride, or a combination thereof, under solution conditions effective to desilicate the molecular sieve; and contacting the desilicated molecular sieve with an ammonium salt under solution conditions effective to form an ammonium exchanged mesoporous molecular sieve. Mesoporous SSZ-91 according to the foregoing may be characterized as having defined pore characteristics, e.g., a total pore volume (measured at P/P0 of 0.95) in the mesopore diameter range is at least about 0.2 cc/g and wherein the micropore volume is at least 0.05 cc/g.

In another aspect, there is provided a hydroconversion process, useful to hydroisomerize hydrocarbon feedstocks, the process comprising contacting a hydrocarbon feed with a hydroisomerization catalyst under hydroisomerization conditions to produce a product; wherein, the hydroisomerization catalyst comprises a mesoporous molecular sieve belonging to the ZSM-48 family of zeolites, the molecular sieve having total pore volume (measured at P/P₀ of 0.95) in the mesopore diameter range is at least about 0.2 cc/g and wherein the micropore volume is at least 0.05 cc/g; and wherein, wherein the molecular sieve comprises a silicon oxide to aluminum oxide mole ratio of 40 to 220, at least 70% polytype 6 of the total ZSM-48-type material present in the molecular sieve, and an additional EUO-type molecular sieve phase in an amount of between 0 and 3.5 percent by weight of the total product; wherein the molecular sieve has a morphology characterized as polycrystalline aggregates comprising crystallites collectively having an average aspect ratio of between about 1 and 8.

### BRIEF DESCRIPTION OF THE DRAWINGS

FIG. 1 depicts the nitrogen isotherm as described in Example 1.

FIG. 2 depicts the pore size distribution (PSD) calculated from the nitrogen isotherm as described in Example 1.

FIG. 3 depicts the nitrogen isotherm as described in Example 5.

FIG. 4 depicts the pore size distribution (PSD) calculated from the nitrogen isotherm as described in Example 5.

FIG. 5 depicts the nitrogen isotherm as described in Example 11.

FIG. 6 depicts the pore size distribution (PSD) calculated from the nitrogen isotherm as described in Example 11.

FIG. 7 depicts the nitrogen isotherm as described in Example 17.

FIG. 8 depicts the pore size distribution (PSD) calculated from the nitrogen isotherm as described in Example 17.

FIG. 9 depicts the nitrogen isotherm as described in Example 20.

FIG. 10 depicts the pore size distribution (PSD) calculated from the nitrogen isotherm as described in Example 20.

### DETAILED DESCRIPTION

Although illustrative embodiments of one or more aspects are provided herein, the disclosed processes may be implemented using any number of techniques. The disclosure is not limited to the illustrative or specific embodiments, any drawings, and any techniques illustrated herein, including any exemplary designs and embodiments illustrated and described herein, and may be modified within the scope of the appended claims along with their full scope of equivalents.

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments is able to learn and understand the different described aspects of the invention. The description of embodiments should facilitate understanding of the invention such that other implementations, not specifically covered but within the ability of a person of skill in the art having read the description of embodiments, to be understood as being consistent with an application of the invention.

Unless otherwise indicated, the following terms have the meanings as defined hereinbelow.

The term “hydroconversion” refers to processes or steps performed in the presence of hydrogen for the hydrocracking, hydrogenation, hydrodeoxygenation, hydrodesulfurization, hydrodenitrogenation, hydrodemetallation, hydrodechlorination, hydrodecarboxylation, hydrodecarbonylation and/or hydrodearomatization (e.g., impurities) of a hydrocarbon or biomass feedstock, and/or for the hydrogenation of unsaturated compounds in the feedstock. Depending on the type of hydrocracking and the reaction conditions, products of hydrocracking processes may have improved aromatic content, oxygen content, viscosities, viscosity indices, saturates content, low temperature properties, volatilities and depolarization, for example.

The term “hydrotreating” refers to processes or steps performed in the presence of hydrogen for the hydrodesulfurization, hydrodenitrogenation, hydrodemetallation, and/or hydrodearomatization of components (e.g., impurities) of a diesel feedstock, and/or for the hydrogenation of unsaturated compounds in the feedstock.

The term “active source” means a reagent or precursor material capable of supplying at least one element in a form that can react and which can be incorporated into the molecular sieve structure. The terms “source” and “active source” can be used interchangeably herein.

The term “molecular sieve” and “zeolite” are synonymous and include (a) intermediate and (b) final or target molecular sieves and molecular sieves produced by (1) direct synthesis or (2) post-crystallization treatment (secondary modification). Secondary synthesis techniques allow for the synthesis of a target material from an intermediate material by heteroatom lattice substitution or other techniques. For example, an aluminosilicate can be synthesized from an intermediate borosilicate by post-crystallization heteroatom lattice substitution of the Al for B. Such techniques are known, for example as described in U.S. Pat. No. 6,790,433 to C. Y. Chen and Stacey Zones, issued Sep. 14, 2004.

The term “*MRE-type molecular sieve” and “EUO-type molecular sieve” includes all molecular sieves and their isotypes that have been assigned the International Zeolite Association framework, as described in the Atlas of Zeolite Framework Types, eds. Ch. Baerlocher, L. B. McCusker and D. H. Olson, Elsevier, 6^{th} revised edition, 2007 and the Database of Zeolite Structures on the International Zeolite Association's website (http://www.iza-online.org).

The term “Periodic Table” refers to the version of IUPAC Periodic Table of the Elements dated Jun. 22, 2007, and the numbering scheme for the Periodic Table Groups is as described in Chem. Eng. News, 63(5), 26-27 (1985).

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

Unless otherwise specified, the recitation of a genus of elements, materials or other components, from which an individual component or mixture of components can be selected, is intended to include all possible sub-generic combinations of the listed components and mixtures thereof. In addition, all number ranges presented herein are inclusive of their upper and lower limit values.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

In preparing SSZ-91, at least one organic compound selective for synthesizing molecular sieves from the ZSM-48 family of zeolites is used as a structure directing agent (“SDA”), also known as a crystallization template. The SDA useful for making SSZ-91 is represented by the following structure (1):

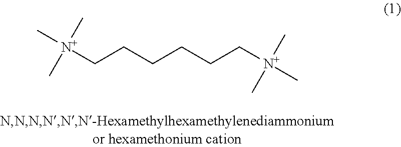

The SDA cation is typically associated with anions which may be any anion that is not detrimental to the formation of the molecular sieve. Representative examples of anions include hydroxide, acetate, sulfate, carboxylate and halogens, for example, fluoride, chloride, bromide and iodide. In one embodiment, the anion is bromide.

In general, SSZ-91 is prepared by (a) preparing a reaction mixture containing (1) at least one source of silicon oxide; (2) at least one source of aluminum oxide; (3) at least one source of an element selected from Groups 1 and 2 of the Periodic Table; (4) hydroxide ions; (5) hexamethonium cations; and (6) water; and (b) maintaining the reaction mixture under crystallization conditions sufficient to form crystals of the molecular sieve.

The composition of the reaction mixture from which the molecular sieve is formed, in terms of mole ratios, is identified in Table 1 below:

TABLE 1

| Components | Broad | Exemplary |
|---|---|---|
| SiO₂/Al₂O₃ | 50-220 | 80-180 |
| M/SiO₂ | 0.05-1.0 | 0.1-0.8 |
| Q/SiO₂ | 0.01-0.2 | 0.02-0.1 |
| OH/SiO₂ | 0.05-0.4 | 0.10-0.3 |
| H₂O/SiO₂ | 3-100 | 10-50 |

wherein,
(1) M is selected from the group consisting of elements from Groups 1 and 2 of the Periodic Table; and
(2) Q is the structure directing agent represented by structure 1 above.

Sources useful herein for silicon include fumed silica, precipitated silica, silica hydrogel, silicic acid, colloidal silica, tetra-alkyl orthosilicates (e.g., tetraethyl orthosilicate), and silica hydroxides.

Sources useful herein for aluminum include aluminates, alumina, and aluminum compounds such as AlCl₃, Al₂(SO₄)₃, Al(OH)₃, kaolin clays, and other zeolites. An example of the source of aluminum oxide is LZ-210 zeolite (a type of Y zeolite).

As described herein above, for each embodiment described herein, the reaction mixture can be formed containing at least one source of an elements selected from Groups 1 and 2 of the Periodic Table (referred to herein as M). In one sub-embodiment, the reaction mixture is formed using a source of an element from Group 1 of the Periodic Table. In another sub-embodiment, the reaction mixture is formed using a source of sodium (Na). Any M-containing compound which is not detrimental to the crystallization process is suitable. Sources for such Groups 1 and 2 elements include oxide, hydroxides, nitrates, sulfates, halides, oxalates, citrates and acetates thereof.

For each embodiment described herein, the molecular sieve reaction mixture can be supplied by more than one source. Also, two or more reaction components can be provided by one source.

The reaction mixture can be prepared either batch wise or continuously. Crystal size, morphology and crystallization time of the molecular sieve described herein can vary with the nature of the reaction mixture and the crystallization conditions.

The reaction mixture is maintained at an elevated temperature until the crystals of the molecular sieve are formed. In general, zeolite hydrothermal crystallization is usually conducted under pressure, and usually in an autoclave so that the reaction mixture is subject to autogenous pressure and optionally stirring, at a temperature between 125° C. and 200° C., for a period of 1 to more than 18 hours.

As noted herein above, SSZ-91 is a substantially phase pure material. As used herein, the term “substantially phase pure material” means the material is completely free of zeolite phases other than those belonging to the ZSM-48 family of zeolites, or are present in quantities that have less than a measurable effect on, or confer less than a material disadvantage to, the selectivity of the material. Two common phases that co-crystalize with SSZ-91 are EUO-type molecular sieves such as EU-1, as well as Magadiite and Kenyaite. These additional phases may be present as separate phases, or may be intergrown with the SSZ-91 phase. As demonstrated in the Examples below, the presence of high amounts of EU-1 in the product is deleterious to the selectivity for hydroisomerization by SSZ-91.

In one embodiment, the SSZ-91 product contains an additional EUO-type molecular sieve phase in an amount of between 0 and 3.5 percent by weight. In one subembodiment, SSZ-91 contains between 0.1 and 2 wt. % EU-1. In another subembodiment, SSZ-91 contains between 0.1 and 1 wt. % EU-1.

It is known that the ratio of powder XRD peak intensities varies linearly as a function of weight fractions for any two phases in a mixture: (Iα/Iβ)=(RIRα/RIRβ)*(xα/xβ), where the RIR (Reference Intensity Ratio) parameters can be found in The International Centre for Diffraction Data's Powder Diffraction File (PDF) database (http://www.icdd.com/products/). The weight percentage of the EUO phase is therefore calculated by measuring the ratio between the peak intensity of the EUO phase and that of the SSZ-91 phase.

The formation of amounts of the EUO phase is suppressed by selecting the optimal hydrogel composition, temperature and crystallization time which minimizes the formation of the EUO phase while maximizing the SSZ-91 product yield. The Examples below provide guidance on how changes in these process variables minimize the formation of EU-1. A zeolite manufacturer with ordinary skill in the art will readily be able to select the process variables necessary to minimize the formation of EU-1, as these variables will depend on the size of the production run, the capabilities of the available equipment, desired target yield and acceptable level of EU-1 material in the product.

During the hydrothermal crystallization step, the molecular sieve crystals can be allowed to nucleate spontaneously from the reaction mixture. The use of crystals of the molecular sieve as seed material can be advantageous in decreasing the time necessary for complete crystallization to occur. In addition, seeding can lead to an increased purity of the product obtained by promoting the nucleation and/or formation of the molecular sieve over any undesired phases. However, it has been found that if seeding is employed, the seeds must be very phase-pure SSZ-91 to avoid the formation of a large amount of a EUO phase. When used as seeds, seed crystals are added in an amount between 0.5% and 5% of the weight of the silicon source used in the reaction mixture.

The formation of Magadiite and Kenyaite is minimized by optimizing the hexamethonium bromide/SiO₂ ratio, controlling the hydroxide concentration, and minimizing the concentration of sodium as Magadiite and Kenyaite are layered sodium silicate compositions.

Once the molecular sieve crystals have formed, the solid product is separated from the reaction mixture by standard mechanical separation techniques such as filtration. The crystals are washed with de-ionized water and then dried to obtain the as-synthesized molecular sieve crystals. The drying step can be performed at atmospheric pressure or under vacuum.

The molecular sieve can be used as-synthesized, but typically will be thermally treated (calcined). The term “as-synthesized” refers to the molecular sieve in its form after crystallization, prior to removal of the SDA cation. The SDA can be removed by thermal treatment (e.g., calcination), preferably in an oxidative atmosphere (e.g., air, gas with an oxygen partial pressure of greater than 0 kPa) at a temperature readily determinable by one skilled in the art sufficient to remove the SDA from the molecular sieve. The SDA can also be removed by ozonation and photolysis techniques (e.g., exposing the SDA-containing molecular sieve product to light or electromagnetic radiation that has a wavelength shorter than visible light under conditions sufficient to selectively remove the organic compound from the molecular sieve) as described in U.S. Pat. No. 6,960,327.

The molecular sieve can subsequently be calcined in steam, air or inert gas at temperatures ranging from 200° C. to 800° C. for periods of time ranging from 1 to 48 hours, or more. Usually, it is desirable to remove the extra-framework cation (e.g., Na⁺) by ion exchange and replace it with hydrogen, ammonium, or any desired metal-ion.

Where the molecular sieve formed is an intermediate molecular sieve, the target molecular sieve can be achieved using post-synthesis techniques such as heteroatom lattice substitution techniques. The target molecular sieve (e.g., silicate SSZ-91) can also be achieved by removing heteroatoms from the lattice by known techniques such as acid leaching.

The molecular sieve made from the process disclosed herein can be formed into a wide variety of physical shapes. Generally speaking, the molecular sieve can be in the form of a powder, a granule, or a molded product, such as extrudate having a particle size sufficient to pass through a 2-mesh (Tyler) screen and be retained on a 400-mesh (Tyler) screen. In cases where the catalyst is molded, such as by extrusion with an organic binder, the molecular sieve can be extruded before drying, or, dried or partially dried and then extruded.

The molecular sieve can be composited with other materials resistant to the temperatures and other conditions employed in organic conversion processes. Such matrix materials include active and inactive materials and synthetic or naturally occurring molecular sieves as well as inorganic materials such as clays, silica and metal oxides. Examples of such materials and the manner in which they can be used are disclosed in U.S. Pat. Nos. 4,910,006 and 5,316,753.

The extrudate or particle may then be further loaded using a technique such as impregnation or ion-exchange, with one or more active metals selected from the group consisting of metals from Groups 8 to 10 of the Periodic Table, to enhance the hydrogenation function. It may be desirable to co-impregnate a modifying metal and one or more Group 8 to 10 metals at once, as disclosed in U.S. Pat. No. 4,094,821. In one embodiment, the at least one active metal is selected from the group consisting of nickel, platinum, palladium, and combinations thereof. After metal loading, the metal loaded extrudate or particle can be calcined in air or inert gas at temperatures from 200° C. to 500° C. In one embodiment, the metal loaded extrudate is calcined in air or inert gas at temperatures from 390° C. to 482° C.

SSZ-91 is useful for a variety of hydrocarbon conversion reactions such as hydrocracking, dewaxing, olefin isomerization, alkylation and isomerization of aromatic compounds and the like. SSZ-91 is also useful as an adsorbent for general separation purposes.

SSZ-91 molecular sieves made by the process disclosed herein have SiO₂/Al₂O₃ mole ratio (SAR) of 40 to 200. The SAR is determined by inductively coupled plasma (ICP) elemental analysis. In one subembodiment, SSZ-91 has a SAR of between 70 and 160. In another subembodiment, SSZ-91 has a SAR of between 80 and 140.

SSZ-91 materials are composed of at least 70% polytype 6 of the total ZSM-48 type material present in the product, as determined by DIFFaX simulation and as described by Lobo and Koningsveld in J. Am. Chem. Soc. 2012, 124, 13222-13230, where the disorder was tuned by three distinct fault probabilities. It should be noted the phrase “at least X %” includes the case where there are no other ZSM-48 polytypes present in the structure, i.e., the material is 100% polytype 6. The structure of polytype 6 is as described by Lobo and Koningsveld. (See, J. Am. Chem. Soc. 2002, 124, 13222-13230). In one embodiment, the SSZ-91 material is composed of at least 80% polytype 6 of the total ZSM-48-type material present in the product. In another embodiment, the SSZ-91 material is composed of at least 90% polytype 6 of the total ZSM-48 type material present in the product. The polytype 6 structure has been given the framework code *MRE by the Structure Commission of the International Zeolite Association.

Molecular sieve SSZ-91 has a morphology characterized as polycrystalline aggregates having a diameter of between about 100 nm and 1.5 μm, each of the aggregates comprising a collection of crystallites collectively having an average aspect ratio of between 1 and 8. As used herein, the term diameter refers to the shortest length on the short end of each crystallite examined. SSZ-91 exhibits a lower degree of hydrocracking than those ZSM-48 materials having a higher aspect ratio. In one subembodiment, the average aspect ratio is between 1 and 5. In another subembodiment, the average aspect ratio is between 1 and 4. In yet another subembodiment, the average aspect ratio is between 1 and 3.

Molecular sieves synthesized by the process disclosed herein can be characterized by their XRD pattern. The powder XRD lines of Table 2 are representative of as-synthesized SSZ-91 made in accordance with the methods described in U.S. Pat. No. 9,802,830. Minor variations in the diffraction pattern can result from variations in the mole ratios of the framework species of the particular sample due to changes in lattice constants. In addition, sufficiently small crystals will affect the shape and intensity of peaks, leading to significant peak broadening. Minor variations in the diffraction pattern can also result from variations in the organic compound used in the preparation and from variations in the Si/Al mole ratio from sample to sample. Calcination can also cause minor shifts in the XRD pattern. Notwithstanding these minor perturbations, the basic crystal lattice structure remains unchanged.

TABLE 2
Characteristic Peaks for As-Synthesized SSZ-91

| | | Relative |
|---|---|---|
| 2-Theta^{(a)} | d-spacing (nm) | Intensity^{(b)} |
| 7.55 | 1.170 | W |
| 8.71 | 1.015 | W |
| 12.49 | 0.708 | W |
| 15.12 | 0.586 | W |
| 21.18 | 0.419 | VS |
| 22.82 | 0.390 | VS |
| 24.62 | 0.361 | W |
| 26.39 | 0.337 | W |
| 29.03 | 0.307 | W |
| 31.33 | 0.285 | W |

^{(a)}±0.20
^{(b)}The powder XRD patterns provided are based on a relative intensity scale in which the strongest line in the X-ray pattern is assigned a value of 100: W = weak (>0 to ≤20); M = medium (>20 to ≤40); S = strong (>40 to ≤60); VS = very strong (>60 to ≤100).

The X-ray diffraction pattern lines of Table 3 are representative of calcined SSZ-91 made in accordance with the methods described herein.

TABLE 3
Characteristic Peaks for Calcined SSZ-91

| | | Relative |
|---|---|---|
| 2-Theta^{(a)} | d-spacing (nm) | Intensity^{(b)} |
| 7.67 | 1.152 | M |
| 8.81 | 1.003 | W |
| 12.61 | 0.701 | W |
| 15.30 | 0.579 | W |
| 21.25 | 0.418 | VS |
| 23.02 | 0.386 | VS |
| 24.91 | 0.357 | W |
| 26.63 | 0.334 | W |
| 29.20 | 0.306 | W |
| 31.51 | 0.284 | W |

^{(a)}±0.20
^{(b)}The powder XRD patterns provided are based on a relative intensity scale in which the strongest line in the X-ray pattern is assigned a value of 100: W = weak (>0 to ≤20); M = medium (>20 to ≤40); S = strong (>40 to ≤60); VS = very strong (>60 to ≤100).

The powder X-ray diffraction patterns presented herein were collected by standard techniques. The radiation was Cuk radiation. The peak heights and the positions, as a function of 2θ where θ is the Bragg angle, were read from the relative intensities of the peaks (adjusting for background), and d, the interplanar spacing corresponding to the recorded lines, can be calculated.

SSZ-91 may be further modified to introduce mesoporosity, and, in particular, to provide mesoporosity that enhances the performance of catalysts made from mesoporous SSZ-91. As is generally known in the art, creating mesopores in zeolite crystals increases the accessible surface area of the catalyst and allows for more rapid diffusion of both reactants and products. These mesopores are often referred to as hierarchical porosity, and can generally be created by two methods: 1) “top-down” strategies where hierarchical porosity is created in zeolite crystals after synthesis, or 2) “bottom-up” strategies where hierarchical porosity is created during the synthesis. While such methods have generally been used for other zeolites, challenges are presented due to unpredictable behavior in achieving economically viable catalytic performance improvements.

Nonetheless, certain methods have been found to be effective to introduce mesoporosity in SSZ-91 such that catalyst prepared therefrom provide enhanced catalytic performance. In accordance with the invention, a mesoporous molecular sieve, such as mesoporous SSZ-91, belonging to the ZSM-48 family of zeolites having a total pore volume (measured at P/P₀ of 0.95) in the mesopore diameter range (2-50 nm) is at least about 0.2 cc/g and wherein the micropore volume is at least 0.05 cc/g, may be made by a method comprising preparing a reaction mixture containing at least one source of silicon, at least one source of aluminum, at least one source of an element selected from Groups 1 and 2 of the Periodic Table, hydroxide ions, hexamethonium cations, and water; and subjecting the reaction mixture to crystallization conditions sufficient to form crystals of the molecular sieve; subjecting the molecular sieve to calcination conditions sufficient to form calcined molecular sieve; contacting the calcined molecular sieve with an organic base, a quaternary ammonium salt, a quaternary ammonium base, an inorganic base, ammonium fluoride, or a combination thereof, under solution conditions effective to desilicate the molecular sieve; and contacting the desilicated molecular sieve with an ammonium salt under solution conditions effective to form an ammonium exchanged mesoporous molecular sieve.

In general, suitable calcination conditions comprise heating the molecular sieve to a temperature in the range of 80 to 140° C. for a time period of 60 to 200 min; and either a) heating the molecular sieve to a temperature in the range of 450 to 550° C. for a time period of 60 to 300 min or b) heating the molecular sieve to a temperature in the range of 560 to 600° C. for a time period of 60 to 300 min; or a combination thereof. The calcination conditions may comprise one or all of the foregoing conditions, e.g., heating the molecular sieve to a temperature in the range of 80 to 140° C. for a time period of 60 to 200 min; heating the molecular sieve to a temperature in the range of 450 to 550° C. for a time period of 60 to 300 min; and heating the molecular sieve to a temperature in the range of 560 to 600° C. for a time period of 60 to 300 min.

Mesoporous SSZ-91 may be made directly from SSZ-91 by contacting calcined SSZ-91 molecular sieve with an organic base, a quaternary ammonium salt, a quaternary ammonium base, an inorganic base, ammonium fluoride, or a combination thereof, under solution conditions effective to desilicate the molecular sieve; and contacting the desilicated molecular sieve with an ammonium salt under solution conditions effective to form an ammonium exchanged mesoporous molecular sieve. While suitable mesoporous SSZ-91 molecular sieve according to the invention has a total pore volume (measured at P/P₀ of 0.95) in the mesopore diameter range (2-50 nm) is at least about 0.2 cc/g and wherein the micropore volume is at least 0.05 cc/g, the foregoing methods may also be used to produce mesoporous SSZ-91 (or other ZSM-48 zeolites) having different pore volume characteristics.

In the foregoing methods, the ammonium salt may comprise, e.g., ammonium halide, such as ammonium chloride or fluoride, ammonium acetate, ammonium nitrate or ammonium sulfate. The concentration of the ammonium salt, e.g., ammonium fluoride, may generally be in the range of 0.01-80 wt. %, or in the range of 1-60 wt. %, or in the range of 10-50 wt. %.

While not limited thereto, the organic base may be, e.g., ammonia, amines, including mono-, di-, and trialkylamines having the general formula R₃₋ₙNHₙ, where R is alkyl and n is from 0 to 2, e.g., methylamine, dimethylamine, trimethylamine, and the like, and/or ammonium compounds, such as, alkylammonium compounds, including those comprising cations having the general formula [R₄₋ₙNHₙ]⁺, where R is alkyl and n is from 1 to 3, as well as combinations thereof. Representative ammonium cations include, e.g., tetraalkyl ammonium compounds, such as tetramethylammonium, tetraethylammonium, tetrapropylammonium, and the like, as well as tri- and tetralkyl ammonium compounds comprising longer chain alkyl groups, e.g., cetyltrialkylammonium compounds such as cetyltrimethyl ammonium. Ammonium counter anions include halides, such as F⁻, Cl⁻, Br⁻, and I⁻, or other anions, such as OH⁻, PF⁶⁻, BF⁴⁻, CH₃COO⁻, SO₄⁻, RCOO⁻ (where R is an alkyl group), and the like, as well as combinations thereof. The concentration of organic base may generally be in the range of 0.001-5 mol/liter, or in the range of 0.01-2 mol/liter, or in the range of 0.02-1.0 mol/liter.

Suitable inorganic bases include, e.g., hydroxides having suitable metal cations, such as sodium, potassium, lithium, and the like, and/or with other cations such as ammonium, as well as combinations thereof. The concentration of inorganic base may generally be in the range of 0.001-5 mol/liter, or in the range of 0.01-2 mol/liter, or in the range of 0.02-1.0 mol/liter.

Suitable quaternary ammonium salts include, e.g., ammonium compounds, such as, alkylammonium compounds, including those comprising cations having the general formula [R₄₋ₙNHₙ]⁺, where R is alkyl and n is from 1 to 3, as well as combinations thereof. Representative ammonium cations include, e.g., tetraalkyl ammonium compounds, such as tetramethylammonium, tetraethylammonium, tetrapropylammonium, and the like, as well as tri- and tetralkyl ammonium compounds comprising longer chain alkyl groups, e.g., cetyltrialkylammonium compounds such as cetyltrimethyl ammonium. Ammonium counter anions include halides, such as F⁻, Cl⁻, Br⁻, and I⁻, or other anions, such as OH, PF⁶⁻, BF⁴⁻, CH₃COO⁻, SO₄⁻, RCOO⁻ (where R is an alkyl group), and the like, as well as combinations thereof. The concentration of the quaternary ammonium salt may generally be in the range of 0.001-5 mol/liter, or in the range of 0.01-2 mol/liter, or in the range of 0.02-1.0 mol/liter.

Suitable quaternary ammonium bases include, e.g., ammonium compounds comprising an hydroxide anion, such as, alkylammonium hydroxide compounds, including those comprising cations having the general formula [R₄₋ₙNHₙ]⁺, where R is alkyl and n is from 1 to 3, as well as combinations thereof. Representative ammonium cations include, e.g., tetraalkyl ammonium compounds, such as tetramethylammonium, tetraethylammonium, tetrapropylammonium, and the like, as well as tri- and tetraklkyl ammonium compounds comprising longer chain alkyl groups, e.g., cetyltrialkylammonium compounds such as cetyltrimethyl ammonium. In addition to an hydroxide anion, suitable ammonium counter anions include halides, such as F⁻, Cl⁻, Br⁻, and I⁻, or other anions, such as PF⁶⁻, BF⁴⁻, CH₃COO⁻, SO₄⁻, RCOO⁻ (where R is an alkyl group), and the like, as well as combinations thereof. The concentration of the quaternary ammonium base may generally be in the range of 0.001-5 mol/liter, or in the range of 0.01-2 mol/liter, or in the range of 0.02-1.0 mol/liter.

While not limited thereto, in general, the ratio of the molecular sieve to solution (wt/wt) is in the range of 0.001-1.0, or in the range of 0.005-0.2, or in the range of 0.01-0.1. Similarly, the ratio of hydroxide (OH⁻) provided by the inorganic base to molecular sieve is generally in the range of 2.5×10⁻⁴ to 1.0×10⁻² mol OH/g-molecular sieve, or in the range of 2.5×10⁻⁴ to 5.0×10⁻³ mol OH/g-molecular sieve, or in the range of 2.5×10⁻⁴ to 3.0×10⁻³ mol OH⁻/g-molecular sieve.

Suitable process conditions include (without limitation) a solution temperature typically in the range of 1-95° C., or in the range of 5-95° C., or in the range of ambient temperature to 95° C., or wherein the solution temperature is up to the solution boiling point; a desilication temperature typically in the range of 1-95° C., or in the range of 5-95° C., or in the range of ambient temperature to 95° C. Agitation of the solution is usually performed, e.g., by stirring, tumbling, sonication or a combination thereof. Separation and recovery of the mesoporous sieve may be carried out by any effective means, e.g., by filtration, centrifugation, settling, or a combination thereof.

The X-ray diffraction pattern lines of Table 4 are representative of calcined mesoporous SSZ-91 made in accordance with the methods described herein.

TABLE 4
Characteristic Peaks for Mesoporous SSZ-91

| | | Relative |
|---|---|---|
| 2-Theta^{(a)} | d-spacing (nm) | Intensity^{(b)} |
| 7.549 | 11.702 | M |
| 8.651 | 10.2128 | W |
| 12.368 | 7.1511 | W |
| 14.56 | 6.0787 | W |
| 15.125 | 5.8531 | W |
| 19.156 | 4.6294 | W |
| 21.152 | 4.1969 | VS |
| 22.911 | 3.8785 | VS |
| 24.672 | 3.6055 | W |
| 26.154 | 3.4045 | W |

^{(a)}±0.20
^{(b)}The powder XRD patterns provided are based on a relative intensity scale in which the strongest line in the X-ray pattern is assigned a value of 100: W = weak (>0 to ≤20); M = medium (>20 to ≤40); S = strong (>40 to ≤60); VS = very strong (>60 to ≤100).

Catalysts may be formed from mesoporous SSZ-91 (or other mesoporous ZSM-48 zeolites according to the invention) by any technique known in the art. Suitable catalysts are loaded with one or more metals from Groups 7 to 10 and Group 14 metals of the Periodic Table, including, e.g., platinum and/or palladium or other precious, noble metals and/or base metals.

Mesoporous SSZ-91 (or other mesoporous ZSM-48 zeolites according to the invention) generally has a silicon oxide to aluminum oxide mole ratio of 40 to 220, at least 70% polytype 6 of the total ZSM-48-type material present in the molecular sieve, and an additional EUO-type molecular sieve phase in an amount of between 0 and 3.5 percent by weight of the molecular sieve; wherein the molecular sieve has a morphology characterized as polycrystalline aggregates comprising crystallites collectively having an average aspect ratio of between about 1 and 8; and wherein the molecular sieve has a total pore volume (measured at P/P₀ of 0.95) in the mesoporous material diameter range (2-50 nm) is at least about 0.2 cc/g and wherein the micropore volume is at least 0.05 cc/g. In some cases, mesoporous SSZ-91 molecular sieve (or other mesoporous ZSM-48 zeolites according to the invention) may have a pore volume at P/P₀ of 0.95 in the mesopore diameter range of at least about 0.2 to 0.6 cc/g, or about 0.22 to 0.55 cc/g, or about 0.22 to 0.0.50 cc/g. In some cases, mesoporous SSZ-91 molecular sieve (or other mesoporous ZSM-48 zeolites according to the invention) may have a total pore volume at P/P₀ of 0.95 of at least about 0.25 cc/g, or in the range of about 0.25 to 0.8 cc/g, or in the range of about 0.28 to 0.65 cc/g, or in the range of about 0.28 to 0.60 cc/g. In some cases, mesoporous SSZ-91 molecular sieve (or other mesoporous ZSM-48 zeolites according to the invention) may have a micropore volume in the range of about 0.05 to 0.100 cc/g, or in the range of about 0.05 to 0.090 cc/g, or in the range of about 0.05 to 0.085 cc/g. In some cases, mesoporous SSZ-91 molecular sieve (or other mesoporous ZSM-48 zeolites according to the invention) may have a BET surface area of at least about 275 m²/g, or in the range of about 275 to 500 m²/g, or in the range of about 275 to 450 m²/g, or in the range of about 275 to 400 m²/g. In some cases, mesoporous SSZ-91 molecular sieve (or other mesoporous ZSM-48 zeolites according to the invention) may have a Brönsted acidity of at least about 175 mmol/g, or in the range of about 175 to 500 mmol/g, or in the range of about 175 to 400 mmol/g, or in the range of about 175 to 300 mmol/g. In some cases, mesoporous SSZ-91 molecular sieve (or other mesoporous ZSM-48 zeolites according to the invention) may have a silica to alumina ratio (SAR) in the range of about 40-200, or in the range of about 40-150, or in the range of about 40-120, or in the range of about 50-200, or in the range of about 50-150, or in the range of about 50-120.

Mesoporous SSZ-91 (or other mesoporous ZSM-48 zeolites according to the invention) provide advantageous hydroconversion capabilities. In one aspect, a hydroconversion process, useful to hydroisomerize hydrocarbon feedstocks, may be carried out using a catalyst comprising the mesoporous molecular sieve, e.g., by contacting a hydrocarbon feed with a hydroisomerization catalyst under hydroisomerization conditions to produce a product; wherein, the hydroisomerization catalyst comprises a mesoporous molecular sieve belonging to the ZSM-48 family of zeolites, the molecular sieve having a total pore volume (measured at P/P₀ of 0.95) in the mesoporous material diameter range (2-50 nm) is at least about 0.2 cc/g and wherein the micropore volume is at least 0.05 cc/g; and wherein, wherein the molecular sieve comprises a silicon oxide to aluminum oxide mole ratio of 40 to 220, at least 70% polytype 6 of the total ZSM-48-type material present in the molecular sieve, and an additional EUO-type molecular sieve phase in an amount of between 0 and 3.5 percent by weight of the total product; wherein the molecular sieve has a morphology characterized as polycrystalline aggregates comprising crystallites collectively having an average aspect ratio of between about 1 and 8. Suitable catalyst according to the foregoing comprise the mesoporous zeolite and a metal selected from Groups 7 to 10 and Group 14 metals of the Periodic Table, such as Pt, Pd, or a combination thereof, or other precious, noble metals and/or base metals. While not limited thereto, the metals content is typically 0.01-5.0 wt. % or 0.01-2.0 wt. %, or 0.1-2.0 wt. % (total catalyst weight basis). The mesoporous material may be combined with other molecular sieves, e.g., for use as a catalyst. Other matrix or support materials may be included as well, including materials such as alumina, silica, titania, or a combination thereof. In general, the catalyst may comprise 0.01 to 5.0 wt. % of the metal, 1 to 80 wt. % of the matrix/support material, and 0.1 to 99 wt. % of the molecular sieve.

Hydroconversion processes may utilize a number of conventional petroleum feedstocks and/or biofeedstocks, including, e.g., gas oil; vacuum gas oil; long residue; vacuum residue; atmospheric distillate; heavy fuel; oil; wax and paraffin; used oil; deasphalted residue or crude; charges resulting from thermal or catalytic conversion processes; shale oil; cycle oil; animal and vegetable derived fats, oils and waxes; petroleum and slack wax; or a combination thereof.

In general, the mesoporous molecular sieve may be used to make catalysts that provide advantageous catalytic performance benefits. For example, in some cases, catalysts according to the invention provide a hydroisomerized hydrocarbon product having a selectivity of 90% or greater, a catalyst activity temperature, measured at 96% conversion, of 585° F. or less, or a light ends production, measured as C₄₋ cracking products produced, of 0.9% or less, or a combination thereof. In some cases, the selectivity is 90% or greater and the catalyst activity temperature is 585° F. or less, or the selectivity is 90% or greater and the light ends production, measured as C₄₋ cracking products produced, is 0.9% or less, or the catalyst activity temperature is 585° F. or less and the light ends production, measured as C₄₋ cracking products produced, is 0.9% or less, or a combination thereof. In some cases, the selectivity is 90% or greater, the catalyst activity temperature is 585° F. or less, and the light ends production, measured as C₄₋ cracking products produced, is 0.9% or less. In some cases, the selectivity is equal to or greater than 91%, or 92%, or wherein the catalyst activity temperature is equal to or less than 582° F., or 580° F., or 575° F., or 570° F., or wherein the light ends production of C₄₋ cracking products is equal to or less than 0.85%, or 0.8%, or 0.7%, or 0.6%, or 0.5%, or 0.4%, 0.3%, or 0.2%, or a combination thereof.

### EXAMPLES

Examples 1-40 demonstrate that catalysts comprising mesoporous ZSM-48 material having the three uniquely combined characteristics of SSZ-91 (low aspect ratio, low EU-1 content, high polytype 6 composition), and possessing mesoporosity as described and exemplified herein, exhibit improved catalytic performance. The following illustrative examples are intended to be non-limiting.

Micropore volume was determined was determined by subjecting the product after drying to a micropore volume analysis using N₂ as adsorbate and via the t-plot method, to provide a micropore volume in cm³/g. See, e.g., Lippens, Bo C., and J. H. De Boer. “Studies on pore systems in catalysts: V. The t method.” Journal of Catalysis 4, no. 3 (1965): 319-323.

The total pore volume was determined via the Gurvich rule based on the adsorbed inert gas amount at a relative pressure of 0.95, i.e., P/P₀=0.95. See, e.g., Thommes, Matthias, et al. “Physisorption of gases, with special reference to the evaluation of surface area and pore size distribution (IUPAC Technical Report).” Pure and applied chemistry 87.9-10 (2015): 1051-1069.

BET surface area was determined according to known procedures. See, e.g., Thommes, Matthias, et al. “Physisorption of gases, with special reference to the evaluation of surface area and pore size distribution (IUPAC Technical Report).” Pure and applied chemistry 87.9-10 (2015): 1051-1069.

Brønsted acid site density was determined by the temperature programmed desorption of n-propylamine. See, e.g., Farneth, W. E., and R. J. Gorte. “Methods for characterizing zeolite acidity.” Chemical reviews 95, no. 3 (1995): 615-635; WO 2016/069073 A1.

The silica to alumina (SAR) molar ratio was determined by Inductively Coupled Plasma Spectroscopy according to known techniques.

### Example 1—Comparative Evaluation of SSZ-91

A sample of zeolite SSZ-91 in the ammonium form was prepared according to U.S. Pat. No. 9,802,830. The material was calcined in air by placing a thin bed in a calcination dish and heated in a muffle furnace from room temperature to 120° C. at a rate of 1° C./min and held for 2 hours. Then, the temperature is ramped up to 540° C. at a rate of 1° C./min and held for 5 hours. The temperature is ramped up again at 1° C./minute to 595° C. and held there for 5 hours. The material was then allowed to cool to room temperature.

The material was then converted to the ammonium form by heating in a solution of ammonium nitrate (typically 1 g NH₄NO₃/1 g zeolite in 10 ml of H₂O at 95° C. for at least 3 hours). The material was then filtered. This was repeated twice for a total of 3 exchanges. At the end, the material was washed with De-ionized (DI) water until the water conductivity is less than 50 μS/cm.

Analysis of the nitrogen isotherm showed a t-plot micropore volume 0.067 cc/g, a t-plot external surface area of 99 m²/g, and a BET surface area of 245 m²/g. The total pore volume was measured at P/P₀=0.95 and found to be 0.26. The silica to alumina molar ratio was found to be 116.

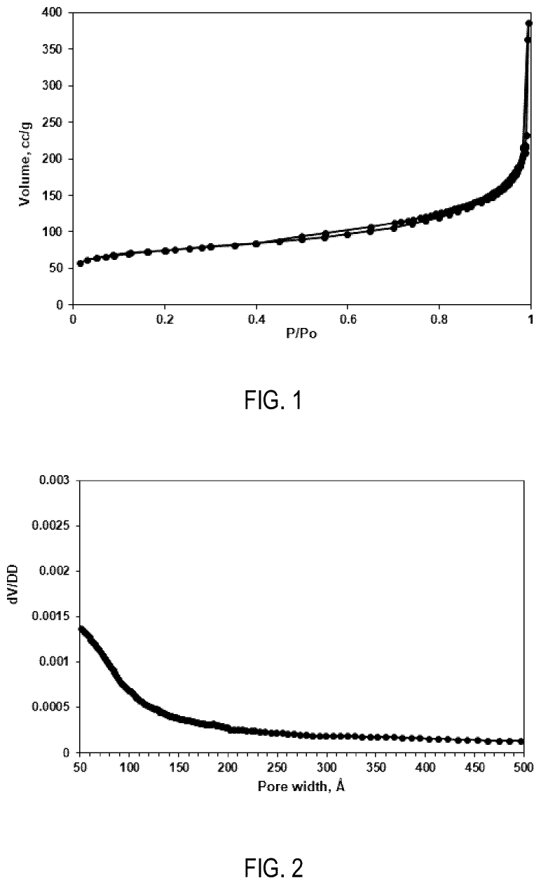

The nitrogen isotherm is shown in FIG. 1 and the pore size distribution (PSD) calculated from the nitrogen isotherm is shown in FIG. 2. The PSD is calculated from Density Functional Theory (DFT), which is a well-known method in the field to calculate PSD. For more details see, as a non-limiting reference, Landers, John, Gennady Yu Gor, and Alexander V. Neimark. “Density functional theory methods for characterization of porous materials.” Colloids and Surfaces A: Physicochemical and Engineering Aspects 437 (2013): 3-32 and Kupgan, Grit, Thilanga P. Liyana-Arachchi, and Coray M. Colina. “NLDFT pore size distribution in amorphous microporous materials.” Langmuir 33, no. 42 (2017): 11138-11145. The shape of the nitrogen isotherm shown in FIG. 1 is typical for a microporous material and the sharp increase in volume near P/P₀=1 is due to intracrystalline condensation. The mesopore size distribution shown in FIG. 2 also does not indicate any significant mesoporosity.

The material was then converted to the ammonium form by heating in a solution of ammonium nitrate (typically 1 g NH₄NO₃/1 g zeolite in 10 mL of H₂O at 95° C. for at least 3 hours). The material was then filtered. This was repeated twice for a total of 3 exchanges. At the end, the material was washed with DI water until the water conductivity of less than 50 μS/cm.

Analysis of the nitrogen isotherm showed a t-plot micropore volume 0.067 cc/g, a t-plot external surface area of 112 m²/g, and a BET surface area of 260 m²/g. The total pore volume was measured at P/P₀=0.95 and found to be 0.26. The silica to alumina molar ratio was found to be 114.

Palladium ion-exchange was carried out on the ammonium-exchanged sample using tetraamminepalladium(II) nitrate (0.5 wt % Pd). After ion-exchange, the sample was dried at 95° C. and then calcined in air at 482° C. for 3 hours to convert the tetraamminepalladium(II) nitrate to palladium oxide. Finally, the material was pelletized crushed and sieved to 20-40 mesh.

### Example 2—Preparation of Mesoporous SSZ-91

A 100 mL solution of 0.12 M NaOH and 0.08 M tetrapropylammonium bromide was prepared and heated to 75° C. Then 4 g of ammonium form SSZ-91 from Example 1 was added and the solution was stirred for 60 minutes at 75° C. The solid was collected by filtration and washed well with DI water to a conductivity of less than 50 μS/cm and then dried in air at 95° C. The material was converted to the ammonium form by heating in a solution of ammonium nitrate (typically 1 g NH₄NO₃/1 g zeolite in 10 mL of H₂O at 95° C. for at least 3 hours). The material was then filtered. This was repeated twice for a total of 3 exchanges. At the end the material was washed with DI water until the water conductivity of less than 50 μS/cm. The yield based on the weight of recovered solids was 59%.

Analysis of the nitrogen isotherm showed a t-plot micropore volume 0.030 cc/g, a t-plot external surface area of 141 m²/g, and a BET surface area of 211 m²/g. The total pore volume was measured at P/P₀=0.95 and found to be 0.51 cc/g. The mesopore diameter as determined the PSD was calculated to be 119 Å. The Brønsted acid site density as determined by the temperature programmed desorption of n-propylamine was found to be 166 μmol H⁺/g.

Analysis of the nitrogen isotherm and the PSD calculated from the nitrogen isotherm indicated only a small change in micropore volume and surface area for the material, but a significant increase in total pore volume, suggesting the formation of mesopores. This is consistent with the nitrogen PSD, which suggests the presence of mesopores.

The material exchanged with palladium contained 0.5 wt % Pd following the procedure in Example 1.

### Example 3

A sample of ammonium form zeolite SSZ-91 was prepared according to Example 1.

Analysis of the nitrogen isotherm showed a t-plot micropore volume 0.071 cc/g, a t-plot external surface area of 85 m²/g, and a BET surface area of 240 m²/g. The total pore volume was measured at P/P₀=0.95 and found to be 0.23. The silica to alumina molar ratio was found to be 121. The Brønsted acid site density as determined by the temperature programmed desorption of n-propylamine was found to be 185 μmol H⁺/g.

### Example 4

A solution of 0.1 M NaOH was heated to 50° C., then 5 g of SSZ-91 from Example 3 was added (50 mL/g-zeolite) and stirred at 50° C. for 60 min. The solid was collected by filtration and washed well with DI water to a conductivity of less than 50 μS/cm and then dried in air at 95° C. The material was then converted to ammonium form following the procedure given in Example 1.

The yield based on the recovered solids was 79%. Analysis of the nitrogen isotherm showed a t-plot micropore volume 0.063 cc/g, a t-plot external surface area of 166 m²/g, and a BET surface area of 305 m²/g. The total pore volume was measured at P/P₀=0.95 and found to be 0.40 cc/g. The silica to alumina molar ratio was found to be 92. The Brønsted acid site density as determined by the temperature programmed desorption of n-propylamine was found to be 248 μmol H⁺/g.

Analysis of the nitrogen and argon isotherms, and the PSD calculated from the isotherms, indicated the material showed only a small change in micropore volume and surface area, but a significant increase in total pore volume, suggesting the formation of mesopores. This is consistent with the nitrogen and argon PSDs, which suggest the presence of mesopores.

The material exchanged with palladium contained 0.5 wt % Pd following the procedure in Example 1.

### Example 5

A solution of 0.3 M NaOH was heated to 50° C., then 10 g of SSZ-91 from Example 3 was added (50 mL/g-zeolite) and stirred at 50° C. for 60 min. The solid was collected by filtration and washed well with DI water to a conductivity of less than 50 μS/cm and then dried in air at 95° C. The material was then converted to ammonium form following the procedure given in Example 1.

The yield based on the recovered solids was 45%. Analysis of the nitrogen isotherm showed a t-plot micropore volume 0.071 cc/g, a t-plot external surface area of 176 m²/g, and a BET surface area of 333 m²/g. The total pore volume was measured at P/P₀=0.95 and found to be 0.61 cc/g. The mesopore diameter as determined the PSD was calculated to be 105 Å. The silica to alumina molar ratio was found to be 68. The Brønsted acid site density as determined by the temperature programmed desorption of n-propylamine was found to be 284 μmol H⁺/g.

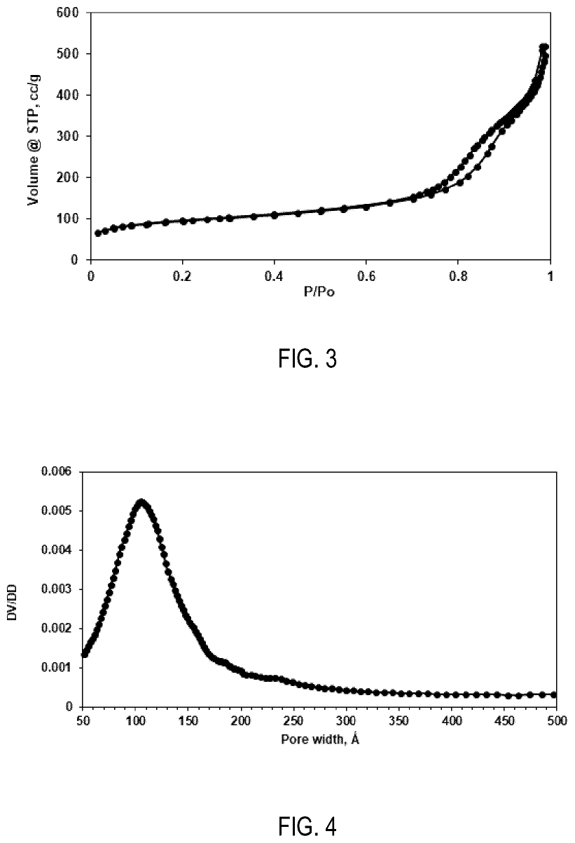

The nitrogen isotherm is shown in FIG. 3 and the PSD calculated from the nitrogen isotherm is shown in FIG. 4. The material showed only a small change in micropore volume and surface area, but a significant increase in total pore volume, suggesting the formation of mesopores. This is consistent with the nitrogen and argon PSDs, which suggest the presence of mesopores.

The material exchanged with palladium contained 0.5 wt % Pd following the procedure in Example 1.

### Example 6

A solution of equal parts 0.1 M NaOH and 0.1 M tetrabutylammonium hydroxide (total hydroxide concentration of 0.1 M) was prepared and heated to 50° C. Then 10 g of SSZ-91 from Example 3 was added (50 mL/g-zeolite) and the solution was stirred for 60 minutes at 50° C. The solid was collected by filtration and washed well with DI water to a conductivity of less than 50 μS/cm and then dried in air at 95° C. The material was then converted to ammonium form following the procedure given in Example 1.

The yield based on the recovered solids was 77%. Analysis of the nitrogen isotherm showed a t-plot micropore volume 0.082 cc/g, a t-plot external surface area of 196 m²/g, and a BET surface area of 379 m²/g. The total pore volume was measured at P/P₀=0.95 and found to be 0.46 cc/g. The silica to alumina molar ratio was found to be 97. The Brønsted acid site density as determined by the temperature programmed desorption of n-propylamine was found to be 242 μmol H⁺/g.

Analysis of the nitrogen and argon isotherms, and the PSD calculated from the isotherms, indicated the material showed only a small change in micropore volume and surface area, but a significant increase in total pore volume, suggesting the formation of mesopores. This is consistent with the nitrogen and argon PSDs, which suggest the presence of mesopores.

The material exchanged with palladium contained 0.5 wt % Pd following the procedure in Example 1.

### Example 7

A sample of as-made zeolite SSZ-91 was prepared according to U.S. Pat. No. 9,802,830. The material was calcined in air by placing a thin bed in a calcination dish and heated in a muffle furnace from room temperature to 120° C. at a rate of 1° C./min. and held for 2 hours. The temperature was ramped up to 540° C. at a rate of 1° C./min. and held for 5 hours. The temperature is ramped up again at 1° C./minute to 595° C. and held there for 5 hours. The material was then allowed to cool to room temperature. The material was not ammonium exchanged.

For analysis purposes a small amount was then converted to ammonium form following the procedure given in Example 1. Analysis of the nitrogen isotherm showed a t-plot micropore volume 0.082 cc/g, a t-plot external surface area of 85 m²/g, and a BET surface area of 263 m²/g. The total pore volume was measured at P/P₀=0.95 and found to be 0.25 cc/g. The silica to alumina molar ratio was found to be 119.

### Example 8

A solution of 0.1 M NaOH was heated to 50° C., then 50 g of SSZ-91 from Example 7 was added (10 mL/g-zeolite) and stirred at 50° C. for 60 min. At the end of the treatment ice was added to quickly cool the solution. The solid was collected by filtration and washed well with DI water to a conductivity of less than 50 μS/cm and then dried in air at 95° C. The material was then converted to ammonium form following the procedure given in Example 1.

The yield based on the recovered solids was 73%. Analysis of the nitrogen isotherm showed a t-plot micropore volume 0.052 cc/g, a t-plot external surface area of 98 m²/g, and a BET surface area of 213 m²/g. The total pore volume was measured at P/P₀=0.95 and found to be 0.26 cc/g. The Brønsted acid site density as determined by the temperature programmed desorption of n-propylamine was found to be 198 μmol H⁺/g.

Analysis of the nitrogen isotherm, and the PSD calculated from the isotherm, indicated the material showed only a small change in micropore volume and surface area, and not a large increase in total pore volume, suggesting limited formation of mesopores. This is consistent with the nitrogen PSD.

The material exchanged with palladium contained 0.5 wt % Pd following the procedure in Example 1.

### Example 9

A solution of 0.1 M NaOH was heated to 50° C., then 10 g of as-synthesized SSZ-91 from Example 7 was added (50 mL/g-zeolite) and stirred at 50° C. for 60 min. At the end of the treatment ice was added to quickly cool the solution. The solid was collected by centrifugation and washed well with DI and then dried in air at 95° C. The material was then converted to ammonium form following the procedure given in Example 1.

The yield based on the recovered solids was 73%. Analysis of the nitrogen isotherm showed a t-plot micropore volume 0.071 cc/g, a t-plot external surface area of 125 m²/g, and a BET surface area of 293 m²/g. The total pore volume was measured at P/P₀=0.95 and found to be 0.29 cc/g. The mesopore diameter as determined the PSD was calculated to be 47 Å. The Brønsted acid site density as determined by the temperature programmed desorption of n-propylamine was found to be 231 μmol H⁺/g.

The material exchanged with palladium contained 0.5 wt % Pd following the procedure in Example 1.

### Example 10

A solution of 0.1 M NaOH was heated to 50° C., then 10 g of SSZ-91 from Example 3 was added (50 mL/g-zeolite) and stirred at 50° C. for 60 min. Ice was added to quickly cool the solution, and the solid was collected by filtration and washed well with DI water to a conductivity of less than 50 μS/cm and then dried in air at 95° C. The material was then converted to ammonium form following the procedure given in Example 1.

The yield based on the recovered solids was 69%. Analysis of the nitrogen isotherm showed a t-plot micropore volume 0.061 cc/g, a t-plot external surface area of 184 m²/g, and a BET surface area of 321 m²/g. The total pore volume was measured at P/P₀=0.95 and found to be 0.47 cc/g. The mesopore diameter as determined the PSD was calculated to be 91 Å. The silica to alumina molar ratio was found to be 80. The Brønsted acid site density as determined by the temperature programmed desorption of n-propylamine was found to be 228 μmol H⁺/g.

Analysis of the nitrogen isotherm, and the PSD calculated from the isotherm, indicated the material showed only a small change in micropore volume and surface area, but a significant increase in total pore volume, suggesting the formation of mesopores. This is consistent with the nitrogen PSD, which suggests the presence of mesopores.

The material exchanged with palladium contained 0.5 wt % Pd following the procedure in Example 1.

### Example 11

A solution of 0.1 M NaOH was heated to 50° C., then 5 g of SSZ-91 from Example 3 was added (100 mL/g-zeolite) and stirred at 50° C. for 60 min. Ice was added to quickly cool the solution, and the solid was collected by filtration and washed well with DI water to a conductivity of less than 50 μS/cm and then dried in air at 95° C. The material was then converted to ammonium form following the procedure given in Example 1.

The yield based on the recovered solids was 55%. Analysis of the nitrogen isotherm showed a t-plot micropore volume 0.071 cc/g, a t-plot external surface area of 207 m²/g, and a BET surface area of 364 m²/g. The total pore volume was measured at P/P₀=0.95 and found to be 0.66 cc/g. The mesopore diameter as determined the PSD was calculated to be 107 Å. The Brønsted acid site density as determined by the temperature programmed desorption of n-propylamine was found to be 269 μmol H⁺/g.

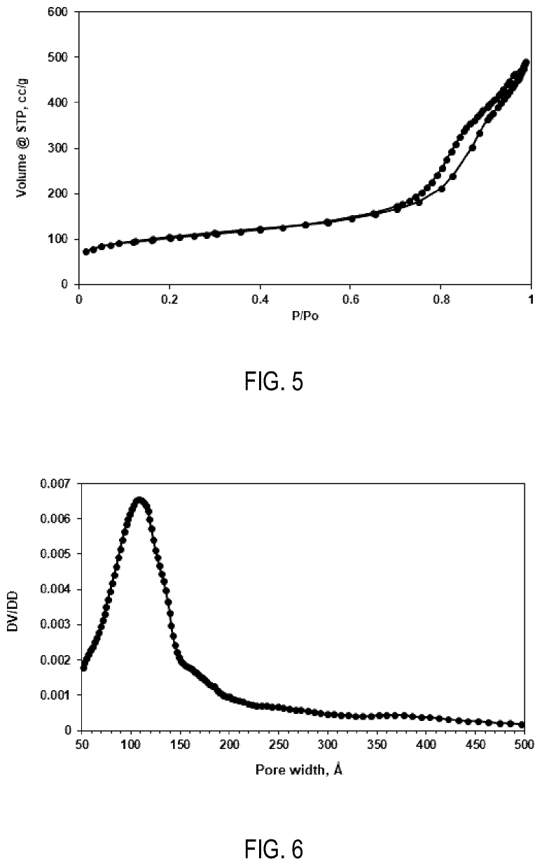

The nitrogen isotherm is shown in FIG. 5 and the PSD calculated from the nitrogen isotherm is in FIG. 6. The material showed only a small change in micropore volume and surface area, but a significant increase in total pore volume, suggesting the formation of mesopores. This is consistent with the nitrogen PSD, which suggests the presence of mesopores.

The material exchanged with palladium contained 0.5 wt % Pd following the procedure in Example 1.

### Example 12

A solution of 0.05 M NaOH was heated to 50° C., then 10 g of SSZ-91 from Example 3 was added (50 mL/g-zeolite) and stirred at 50° C. for 60 min. Ice was added to quickly cool the solution, and the solid was collected by filtration and washed well with DI water to a conductivity of less than 50 μS/cm and then dried in air at 95° C. The material was then converted to ammonium form following the procedure given in Example 1.

The yield based on the recovered solids was 83%. Analysis of the nitrogen isotherm showed a t-plot micropore volume 0.061 cc/g, a t-plot external surface area of 143 m²/g, and a BET surface area of 278 m²/g. The total pore volume was measured at P/P₀=0.95 and found to be 0.33 cc/g. The mesopore diameter as determined the PSD was calculated to be 49 Å. The Brønsted acid site density as determined by the temperature programmed desorption of n-propylamine was found to be 231 μmol H⁺/g.

Analysis of the nitrogen isotherm, and the PSD calculated from the isotherm, indicated the material showed only a small change in micropore volume and surface area, but a significant increase in total pore volume, suggesting the formation of mesopores. This is consistent with the nitrogen PSDs, which suggest the presence of mesopores.

The material exchanged with palladium contained 0.5 wt % Pd following the procedure in Example 1.

### Example 13

A solution of 0.1 M tetrapropylammonium hydroxide was heated to 50° C., then 10 g of SSZ-91 from Example 3 was added (50 mL/g-zeolite) and stirred at 50° C. for 60 min. Ice was added to quickly cool the solution, and the solid was collected by filtration and washed well with DI water to a conductivity of less than 50 μS/cm and then dried in air at 95° C. The material was then converted to ammonium form following the procedure given in Example 1.

The yield based on the recovered solids was 95%. Analysis of the nitrogen isotherm showed a t-plot micropore volume 0.062 cc/g, a t-plot external surface area of 95 m²/g, and a BET surface area of 230 m²/g. The total pore volume was measured at P/P₀=0.95 and found to be 0.24 cc/g. The Brønsted acid site density as determined by the temperature programmed desorption of n-propylamine was found to be 212 μmol H⁺/g.

Analysis of the nitrogen isotherm, and the PSD calculated from the isotherm, indicated the material showed only a small change in micropore volume and surface area, and not a large increase in total pore volume, suggesting limited formation of mesopores. This is consistent with the nitrogen PSD.

The material exchanged with palladium contained 0.5 wt % Pd following the procedure in Example 1.

### Example 14

A solution of 0.1 M NaOH was heated to 50° C., then 10 g of SSZ-91 from Example 7 was added (50 mL/g-zeolite) and stirred at 50° C. for 30 min. Ice was added to quickly cool the solution, and the solid was collected by filtration and washed well with DI water to a conductivity of less than 50 μS/cm and then dried in air at 95° C. The material was then converted to ammonium form following the procedure given in Example 1.

The yield based on the recovered solids was 66%. Analysis of the nitrogen isotherm showed a t-plot micropore volume 0.057 cc/g, a t-plot external surface area of 186 m²/g, and a BET surface area of 315 m²/g. The total pore volume was measured at P/P₀=0.95 and found to be 0.51 cc/g. The mesopore diameter as determined the PSD was calculated to be 83 Å. The silica to alumina molar ratio was found to be 81. The Brønsted acid site density as determined by the temperature programmed desorption of n-propylamine was found to be 255 μmol H⁺/g.

Analysis of the nitrogen isotherm, and the PSD calculated from the isotherm, indicated the material showed only a small change in micropore volume and surface area, but a significant increase in total pore volume, suggesting the formation of mesopores. This is consistent with the nitrogen PSDs, which suggest the presence of mesopores.

The material exchanged with palladium contained 0.5 wt % Pd following the procedure in Example 1.

### Example 15

A solution of 0.1 M NaOH was heated to 50° C., then 10 g of SSZ-91 from Example 7 was added (50 mL/g-zeolite) and stirred at 50° C. for 120 min. Ice was added to quickly cool the solution, and the solid was collected by filtration and washed well with DI water to a conductivity of less than 50 μS/cm and then dried in air at 95° C. The material was then converted to ammonium form following the procedure given in Example 1.

The yield based on the recovered solids was 64%. Analysis of the nitrogen isotherm showed a t-plot micropore volume 0.060 cc/g, a t-plot external surface area of 168 m²/g, and a BET surface area of 300 m²/g. The total pore volume was measured at P/P₀=0.95 and found to be 0.49 cc/g. The mesopore diameter as determined the PSD was calculated to be 87 Å. The silica to alumina molar ratio was found to be 80. The Brønsted acid site density as determined by the temperature programmed desorption of n-propylamine was found to be 248 μmol H⁺/g.

Analysis of the nitrogen isotherm, and the PSD calculated from the isotherm, indicated the material showed only a small change in micropore volume and surface area, but a significant increase in total pore volume, suggesting the formation of mesopores. This is consistent with the nitrogen PSDs, which suggest the presence of mesopores.

The material exchanged with palladium contained 0.5 wt % Pd following the procedure in Example 1.

### Example 16

To a solution of 0.1 M NaOH at ambient temperature, 26° C., 30 g of SSZ-91 from Example 7 was added (50 mL/g-zeolite) and stirred at temperature, 26° C. for 60 min. The solid was collected by filtration and washed well with DI water to a conductivity of less than 50 μS/cm and then dried in air at 95° C. The product yield based on the recovered solids at this step was 91%. The material was then converted to ammonium form following the procedure given in Example 1.

The yield based on the recovered solids was 75%. Analysis of the nitrogen isotherm showed a t-plot micropore volume 0.055 cc/g, a t-plot external surface area of 115 m²/g, and a BET surface area of 237 m²/g. The total pore volume was measured at P/P₀=0.95 and found to be 0.29 cc/g. The silica to alumina molar ratio was found to be 104. The Brønsted acid site density as determined by the temperature programmed desorption of n-propylamine was found to be 220 μmol H⁺/g.

### Example 17

A solution of 0.1 M NaOH was heated to 50° C., then 30 g of SSZ-91 from Example 7 was added (50 mL/g-zeolite) and stirred at 50° C. for 30 min. The solid was collected by filtration and washed well with DI water to a conductivity of less than 50 μS/cm and then dried in air at 95° C. The product yield based on the recovered solids at this step was 73%. The material was then converted to ammonium form following the procedure given in Example 1.

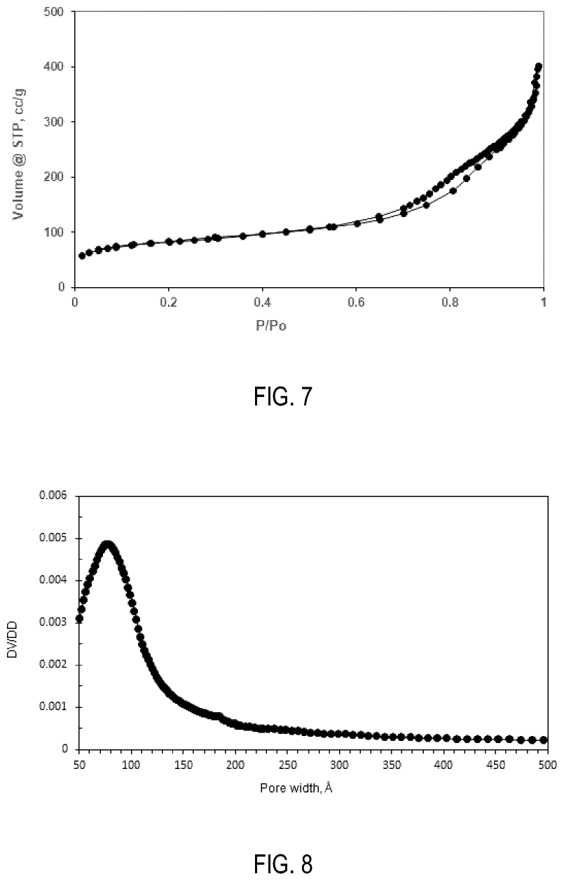

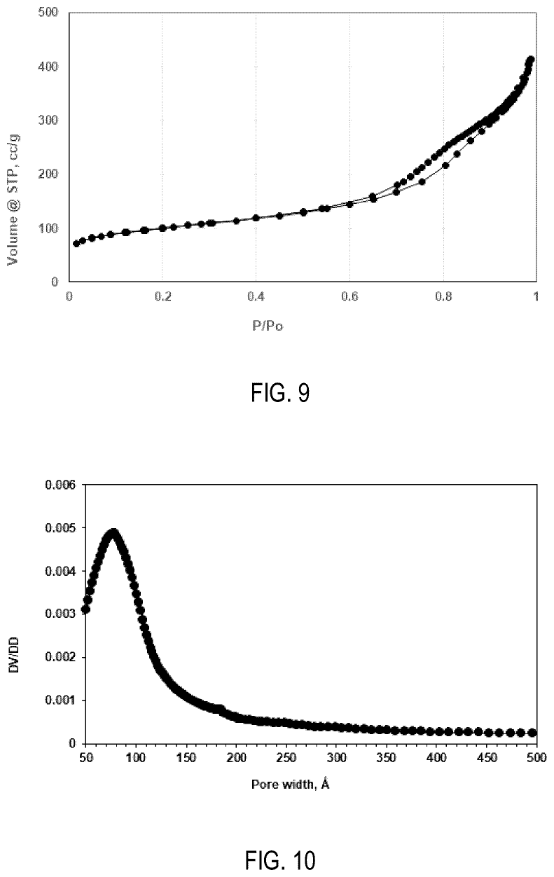

The yield based on the recovered solids was 65%. The nitrogen isotherm and the PSD calculated from the isotherm are shown in FIG. 7 and FIG. 8. Analysis of the nitrogen isotherm showed a t-plot micropore volume 0.058 cc/g, a t-plot external surface area of 161 m²/g, and a BET surface area of 289 m²/g. The total pore volume was measured at P/P₀=0.95 and found to be 0.35 cc/g. The mesopore diameter as determined the PSD was calculated to be 83 Å. The silica to alumina molar ratio was found to be 81. The Brønsted acid site density as determined by the temperature programmed desorption of n-propylamine was found to be 247 μmol H⁺/g.

### Example 18

A solution of 0.1 M NaOH was heated to 50° C., then 30 g of SSZ-91 from Example 7 was added (50 mL/g-zeolite) and stirred at 50° C. for 15 min. The solid was collected by filtration and washed well with DI water to a conductivity of less than 50 μS/cm and then dried in air at 95° C. The product yield based on the recovered solids at this step was 76%. The material was then converted to ammonium form following the procedure given in Example 1.

The yield based on the recovered solids was 68%. Analysis of the nitrogen isotherm showed a t-plot micropore volume 0.058 cc/g, a t-plot external surface area of 155 m²/g, and a BET surface area of 285 m²/g. The total pore volume was measured at P/P₀=0.95 and found to be 0.42 cc/g. The mesopore diameter as determined the PSD was calculated to be 79 Å. The silica to alumina molar ratio was found to be 85. The Brønsted acid site density as determined by the temperature programmed desorption of n-propylamine was found to be 240 μmol H⁺/g.

### Example 19

A solution of 0.05 M NaOH was heated to 50° C., then 80 g of SSZ-91 from Example 7 was added (50 mL/g-zeolite) and stirred at 50° C. for 45 min. The solid was collected by filtration and washed well with DI water to a conductivity of less than 50 μS/cm and then dried in air at 95° C. The product yield based on the recovered solids at this step was 80%. The material was then converted to ammonium form following the procedure given in Example 1.

The yield based on the recovered solids was 74%. Analysis of the nitrogen isotherm showed a t-plot micropore volume 0.063 cc/g, a t-plot external surface area of 174 m²/g, and a BET surface area of 315 m²/g. The total pore volume was measured at P/P₀=0.95 and found to be 0.36 cc/g. The mesopore diameter as determined the PSD was calculated to be 47 Å. The silica to alumina molar ratio was found to be 93. The Brønsted acid site density as determined by the temperature programmed desorption of n-propylamine was found to be 236 μmol H⁺/g.

### Example 20

A solution of 0.05 M NaOH was heated to 50° C., then 80 g of SSZ-91 from Example 7 was added (50 mL/g-zeolite) and stirred at 50° C. for 60 min. The solid was collected by filtration and washed well with DI water to a conductivity of less than 50 μS/cm and then dried in air at 95° C. The product yield based on the recovered solids was 65%. The material was then converted to ammonium form following the procedure given in Example 1.

Analysis of the nitrogen isotherm showed a t-plot micropore volume 0.064 cc/g, a t-plot external surface area of 211 m²/g, and a BET surface area of 353 m²/g. The total pore volume was measured at P/P₀=0.95 and found to be 0.53 cc/g. The mesopore diameter as determined the PSD was calculated to be 77 Å. The silica to alumina molar ratio was found to be 74. The Brønsted acid site density as determined by the temperature programmed desorption of n-propylamine was found to be 269 μmol H⁺/g.

### Example 21—Hydroisomerization of n-hexadecane Based on Example 1

0.5 g of the palladium exchanged sample from Example 1 was loaded in the center of a 23 inch-long by 0.25 inch outside diameter stainless steel reactor tube with alundum loaded upstream of the catalyst for pre-heating the feed (total pressure of 1200 psig; down-flow hydrogen rate of 160 mL/min (when measured at 1 atmosphere pressure and 25° C.); down-flow liquid feed rate of 1 mL/hour. All materials were first reduced in flowing hydrogen at about 315° C. for 1 hour. Products were analyzed by on-line capillary gas chromatography (GC) once every thirty minutes. Raw data from the GC was collected by an automated data collection processing system and hydrocarbon conversions were calculated from the raw data.

Conversion was defined as the amount of hexadecane reacted to produce other products (including iso-nC₁₆ isomers). Yields were expressed as weight percent of products other than n-C₁₆ and included iso-C₁₆ as a yield product. The results at 96% conversion are reported in Table 5.

### Examples 22-40—Hydroisomerization of n-Hexadecane Based on Examples 2-20

The catalytic testing was conducted in the same manner as Example 21 (using the material of Example 1) except that the catalyst used the material from Examples 2-20, respectively. The results at 96% conversion are reported in Table 5. The desirable isomerization selectivity at 96% conversion for the preferred materials of this invention is at least 87%. A good balance between isomerization selectivity and temperature at 96% conversion is critical for this invention. The desirable temperature at 96% conversion is less than 600° F. The lower the temperature at 96% conversion the more desirable is the catalyst. The best catalytic performance is dependent on the synergy between isomerization selectivity and temperature at 96% conversion. Undesirable catalytic cracking with concomitant high gas make are shown in Table 5 by an increased level of C₄₋ cracking. The desirable C₄₋ cracking for the materials of this invention is below 1.0%, or less than 0.9%.

TABLE 5
Summary of n-Hexadecane Hydroconversion at 96% Conversion

| Catalyst | Preparation | Isomerization | Temp./ | C₄- |
|---|---|---|---|---|
| Example No. | Example No. | Selectivity | ° F. | Cracking |
| 21 | 1 | 87% | 592 | 1.2% |
| 22 | 2 | 89% | 638 | 1.1% |
| 23 | 3 | 88% | 597 | 1.1% |
| 24 | 4 | 93% | 581 | 0.6% |
| 25 | 5 | 93% | 576 | 0.6% |
| 26 | 6 | 92% | 580 | 0.6% |
| 27 | 7 | 89% | 594 | 1.0% |
| 28 | 8 | 90% | 589 | 0.9% |
| 29 | 9 | 88% | 575 | 1.1% |
| 30 | 10 | 93% | 573 | 0.6% |
| 31 | 11 | 93% | 572 | 0.6% |
| 32 | 12 | 92% | 574 | 0.7% |
| 33 | 13 | 87% | 578 | 1.1% |
| 34 | 14 | 93% | 577 | 0.6% |
| 35 | 15 | 93% | 577 | 0.6% |
| 36 | 16 | 90% | 579 | 0.7% |
| 37 | 17 | 93% | 573 | 0.6% |
| 38 | 18 | 93% | 576 | 0.6% |
| 39 | 19 | 92% | 571 | 0.6% |
| 40 | 20 | 94% | 566 | 0.5% |

It will be understood that the invention is not limited to the embodiments described above and various modifications and improvements can be made without departing from the concepts described herein. Except where mutually exclusive, any of the features may be employed separately or in combination with any other features and the disclosure extends to and includes all combinations and sub-combinations of one or more features described herein.

Additional details concerning the scope of the invention and disclosure may be determined from the appended claims.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

1. A mesoporous molecular sieve belonging to the ZSM-48 family of zeolites, wherein the molecular sieve comprises:
a silicon oxide to aluminum oxide mole ratio of 40 to 220,
at least 70% polytype 6 of the total ZSM-48-type material present in the molecular sieve, and
an additional EUO-type molecular sieve phase in an amount of between 0 and 3.5 percent by weight of the molecular sieve;
wherein the molecular sieve has a morphology characterized as polycrystalline aggregates comprising crystallites collectively having an average aspect ratio of between about 1 and 8; and
wherein the molecular sieve has a total pore volume at P/P₀ of 0.95 in the mesopore diameter range of at least about 0.2 cc/g and a micropore volume of at least 0.05 cc/g.

2. (canceled)

3. The molecular sieve of claim 1, wherein the molecular sieve is an SSZ-91 molecular sieve.

4. The molecular sieve of claim 1, wherein the molecular sieve has a total pore volume at P/P₀ of 0.95 of at least about 0.25 cc/g, or in the range of about 0.25 to 0.8 cc/g, or in the range of about 0.28 to 0.65 cc/g, or in the range of about 0.28 to 0.60 cc/g.

5. The molecular sieve of claim 1, wherein the molecular sieve has a total pore volume at P/P₀ of 0.95 in the mesopore diameter range of at least about 0.2 to 0.6 cc/g, or about 0.22 to 0.55 cc/g, or about 0.22 to 0.0.50 cc/g.

6. The molecular sieve of claim 1, wherein the molecular sieve has a micropore volume in the range of about 0.05 to 0.100 cc/g, or in the range of about 0.05 to 0.090 cc/g, or in the range of about 0.05 to 0.085 cc/g.

7. The molecular sieve of claim 1, wherein the molecular sieve has a BET surface area of at least about 275 m²/g, or in the range of about 275 to 500 m²/g, or in the range of about 275 to 450 m²/g, or in the range of about 275 to 400 m²/g.

8. The molecular sieve of claim 1, wherein the molecular sieve has a Brönsted acidity of at least about 175 mmol/g, or in the range of about 175 to 500 mmol/g, or in the range of about 175 to 400 mmol/g, or in the range of about 175 to 300 mmol/g.

9. The molecular sieve of claim 1, wherein the molecular sieve has a silica to alumina ratio (SAR) in the range of about 40-200, or in the range of about 40-150, or in the range of about 40-120.

10. A method for making a mesoporous molecular sieve belonging to the ZSM-48 family of zeolites, the molecular sieve having a total pore volume at P/P₀ of 0.95 in the mesopore diameter range of at least about 0.2 cc/g and a micropore volume of at least 0.05 cc/g, the method comprising:
preparing a reaction mixture containing at least one source of silicon, at least one source of aluminum, at least one source of an element selected from Groups 1 and 2 of the Periodic Table, hydroxide ions, hexamethonium cations, and water;
subjecting the reaction mixture to crystallization conditions sufficient to form crystals of the molecular sieve;
subjecting the molecular sieve to calcination conditions sufficient to form calcined molecular sieve;
contacting the calcined molecular sieve with an organic base, a quaternary ammonium salt, a quaternary ammonium base, an inorganic base, ammonium fluoride, or a combination thereof, under solution conditions effective to desilicate the molecular sieve; and
contacting the desilicated molecular sieve with an ammonium salt under solution conditions effective to form an ammonium exchanged mesoporous molecular sieve.

11. The method of claim 10, wherein the calcination conditions comprise heating the molecular sieve to a temperature in the range of 80 to 140° C. for a time period of 60 to 200 min; heating the molecular sieve to a temperature in the range of 450 to 550° C. for a time period of 60 to 300 min; heating the molecular sieve to a temperature in the range of 560 to 600° C. for a time period of 60 to 300 min; or a combination thereof.

12. The method of claim 11, wherein the calcination conditions comprise heating the molecular sieve to a temperature in the range of 80 to 140° C. for a time period of 60 to 200 min; heating the molecular sieve to a temperature in the range of 450 to 550° C. for a time period of 60 to 300 min; and heating the molecular sieve to a temperature in the range of 560 to 600° C. for a time period of 60 to 300 min.

13. The method of claim 10, wherein the mesoporous molecular sieve is SSZ-91.

14. The method of claim 10, wherein the ammonium salt contacted with the desilicated molecular sieve comprises ammonium halide, ammonium chloride, ammonium acetate, ammonium nitrate or ammonium sulfate.

15. A method for making a mesoporous SSZ-91 molecular sieve having a total pore volume (measured at P/P₀ of 0.95) in the mesopore diameter range is at least about 0.2 cc/g, the method comprising:
contacting calcined SSZ-91 molecular sieve with an organic base, a quaternary ammonium salt, a quaternary ammonium base, an inorganic base, ammonium fluoride, or a combination thereof, under solution conditions effective to desilicate the molecular sieve; and
contacting the desilicated molecular sieve with an ammonium salt under solution conditions effective to form an ammonium exchanged mesoporous molecular sieve.

16. The method of claim 15, wherein the calcined SSZ-91 calcination conditions comprise heating the molecular sieve to a temperature in the range of 80 to 140° C. for a time period of 60 to 200 min; and a) heating the molecular sieve to a temperature in the range of 450 to 550° C. for a time period of 60 to 300 min; or b) heating the molecular sieve to a temperature in the range of 560 to 600° C. for a time period of 60 to 300 min; or a combination thereof.

17. The method of claim 15, wherein the calcined SSZ-91 calcination conditions comprise heating the molecular sieve to a temperature in the range of 80 to 140° C. for a time period of 60 to 200 min; heating the molecular sieve to a temperature in the range of 450 to 550° C. for a time period of 60 to 300 min; and heating the molecular sieve to a temperature in the range of 560 to 600° C. for a time period of 60 to 300 min.

18. The method of claim 10, wherein the concentration of inorganic base is in the range of 0.001-5 mol/liter, or in the range of 0.01-2 mol/liter, or in the range of 0.02-1.0 mol/liter.

19. The method of claim 10, wherein the concentration of ammonium salt contacted with the desilicated molecular sieve is in the range of 0.01-80 wt. %, or in the range of 1-60 wt. %, or in the range of 10-50 wt. %.

20. The method of claim 10, wherein the ratio of the molecular sieve to solution (wt/wt) is in the range of 0.001-1.0, or in the range of 0.005-0.2, or in the range of 0.01-0.1.

21. The method of claim 10, wherein the ratio of hydroxide (OH⁻) provided by the inorganic base to molecular sieve is in the range of 2.5×10⁻⁴ to 1.0×10⁻² mol OH⁻/g-molecular sieve, or in the range of 2.5×10⁻⁴ to 5.0×10⁻³ mol OH⁻/g-molecular sieve, or in the range of 2.5×10⁻⁴ to 3.0×10⁻³ mol OH⁻/g-molecular sieve.

22. The method of claim 10, wherein the solution temperature is in the range of 1-95° C., or in the range of 5-95° C., or in the range of ambient temperature to 95° C., or wherein the solution temperature is up to the solution boiling point.

23. The method of claim 10, wherein the desilication temperature is in the range of 1-95° C., or in the range of 5-95° C., or in the range of ambient temperature to 95° C.

24. The method of claim 10, wherein the method comprises agitation of the solution by stirring, tumbling, sonication or a combination thereof.

25. The method of claim 10, wherein the method comprises separating the molecular sieve from the solution by filtration, centrifugation, settling, or a combination thereof.

26. A catalyst comprising the molecular sieve of claim 1 and a metal selected from Groups 7 to 10 and Group 14 metals of the Periodic Table or the metal comprises Pt, Pd, or a combination thereof.

27-28. (canceled)

29. A hydroconversion process, useful to hydroisomerize hydrocarbon feedstocks, the process comprising
contacting a hydrocarbon feed with a hydroisomerization catalyst under hydroisomerization conditions to produce a product;
wherein, the hydroisomerization catalyst comprises the molecular sieve of claim 1 or SSZ-91.

30-49. (canceled)
